(19) United States
(12) Patent Application Publication
(10) Pub. No.: US 2013/0177437 A1
(43) Pub. Date: Jul. 11, 2013

(54) PROCESSES FOR COATING A TURBINE ROTOR AND ARTICLES THEREOF

(71) Applicants: SUNDAR AMANCHERLA, Bangalore (IN); KRISHNAMURTHY ANAND, Bangalore (IN); EKLAVYA CALLA, Bangalore (IN); JON CONRAD SCHAEFFER, Simpsonville, SC (US); HARIHARAN SUNDARAM, Bangalore (IN)

(72) Inventors: SUNDAR AMANCHERLA, Bangalore (IN); KRISHNAMURTHY ANAND, Bangalore (IN); EKLAVYA CALLA, Bangalore (IN); JON CONRAD SCHAEFFER, Simpsonville, SC (US); HARIHARAN SUNDARAM, Bangalore (IN)

(73) Assignee: GENERAL ELECTRIC COMPANY, Schenectady, NY (US)

(21) Appl. No.: 13/344,363

(22) Filed: Jan. 5, 2012

(51) Int. Cl. F01D 5/02; B05D 1/00

(52) U.S. Cl. 416/241 R; 427/203

(57) ABSTRACT

A process for applying a hard coating to a turbine rotor comprising providing a turbine rotor having at least one surface; applying a first coating to the at least one surface, the first coating being cold sprayed onto the at least one surface; applying a second coating onto the first coating to form the hard coating, wherein the hard coating is configured to substantially resist wear of a brush seal in physical communication with the turbine rotor.

### BACKGROUND OF THE INVENTION

The subject matter disclosed herein relates to processes for coating a turbine rotor used in turbine engine applications. The processes provide a coating on a surface of the turbine rotor configured to reduce the wear of brush seals in the turbine engine.

Turbine engines, such as found in jet aircraft and power generation systems, typically include at least one shaft that normally rotates at a relatively high speed. In fact, the turbine engine may include multiple shafts that normally operate at high speeds while passing through several zones of varying pressures. Turbine engines can create, for example, thrust by compressing atmospheric air, mixing fuel with the compressed air and igniting it, and passing the ignited and expanded air/fuel mixture through a turbine. Zones having various pressures exist throughout the length of the engine. These zones must typically be sealed from one another in order to allow the engine to operate, and in particular to increase the efficiency of the turbine engine. In addition to the high rotational speeds of an engine shaft, axial and radial shaft movement increases the difficulties associated with maintaining effective seals throughout the lifetime of the engine. An effective seal must be able to continuously accommodate both axial and radial shaft movement while maintaining the seal. When rigid seals are installed, shaft movement can create excessive wear leading to an ineffective seal.

Seals that are used in order to accommodate the shaft movement mentioned above include brush seals and labyrinth seals. Numerous configurations of these seals for use with shafts are known in the art. Brush seals typically include a ring-shaped body member or holder having bristles extending therefrom. The bristles may extend radially inwardly or radially outwardly from the holder. In a typical configuration, the bristles contact the rotating member, such as a turbine rotor, while the holder is fixed to a stationary support member. The bristles are flexible enough to allow the shaft to rotate against it, and to move both axially and radially, while effectively maintaining a seal. The bristles may be constructed from a variety of materials. One common construction is the use of metal or ceramic bristles that are held by the holder at one end and are free and in contact with the moving shaft at the other end. Another construction includes a series of interlocking fingers.

However, the high shaft speeds often cause the bristle portion contacting the shaft to deteriorate due to shaft eccentricity and the amount of heat that is quickly generated at the shaft/brush interface. When the bristle portions are constructed from a stronger material (e.g. ceramics), the section of the shaft contacting the bristle portion undesirably wears causing the entire shaft to require replacement or rehabilitation. The frictional engagement of the brush with the rotating member also creates the undesirable generation of heat.

Accordingly, it is desirable to provide a high speed shaft surface, such as that of a turbine rotor, which mitigates the wear of brush and labyrinth seals, thereby improving the reliability and operating life of a turbine engine.

### BRIEF DESCRIPTION OF THE INVENTION

According to one aspect of the invention, a process for applying a hard coating to a turbine rotor comprising applying a first coating to at least one surface of a turbine rotor, the first coating being cold sprayed onto the at least one surface; applying a second coating onto the first coating to form the hard coating, wherein the hard coating is configured to substantially resist wear of a brush seal in physical communication with the turbine rotor.

According to another aspect of the invention, a turbine rotor in physical communication with a brush seal comprises at least one turbine rotor surface; and a hard coating comprising a bond coat layer and at least one wear resistant layer disposed on the at least one turbine rotor surface, at least the bond coat layer being cold sprayed on the at least one turbine rotor surface, wherein the hard coating is configured to substantially resist wear of the brush seal during rotation of the turbine rotor.

According to yet another aspect of the invention, a process of substantially resisting surface wear of a brush seal system in a turbine engine comprises applying a hard coating to at least one surface of a turbine rotor, wherein the at least one surface is in physical communication with the brush seal system, and wherein applying the hard coating comprises cold spraying a first coating to the at least one surface; and applying a second coating onto the first coating to form the hard coating.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an exemplary apparatus for cold spraying the coating onto a surface of the turbine rotor; and

FIG. 2 is a schematic illustration of an exemplary embodiment of a coating on a turbine rotor surface.

The detailed description explains embodiments of the invention, together with advantages and features, by way of example with reference to the drawings.

### DETAILED DESCRIPTION OF THE INVENTION

Disclosed herein is are processes for applying a coating to a turbine rotor that substantially reduces surface wear of brush and labyrinth seals compared to a turbine rotor without the coating. Specifically disclosed is a process for applying a multilayer coating to the turbine rotor surface, wherein a bond coat layer is applied by a technique known as cold gas dynamic spraying or “cold spraying.” The cold spray process for depositing powdered materials onto the outer surface of a turbine rotor is advantageous in that it provides sufficient energy to accelerate particles to high enough velocities such that, upon impact, the particles plastically deform and bond to the surface of the component being restored or onto a previously deposited layer. The cold spray process allows the build up of a relative dense coating or structural deposit. Cold spray does not metallurgically transform the particles from their solid state, but it does cold work the powder causing the material to have an increased hardness. In other words, cold spray application of a bond coat layer on the turbine rotor avoids exposing the rotor to high temperatures, induces compressive residual stresses into the rotor, and therefore, likely does not impact the fatigue properties of the coated turbine rotor.

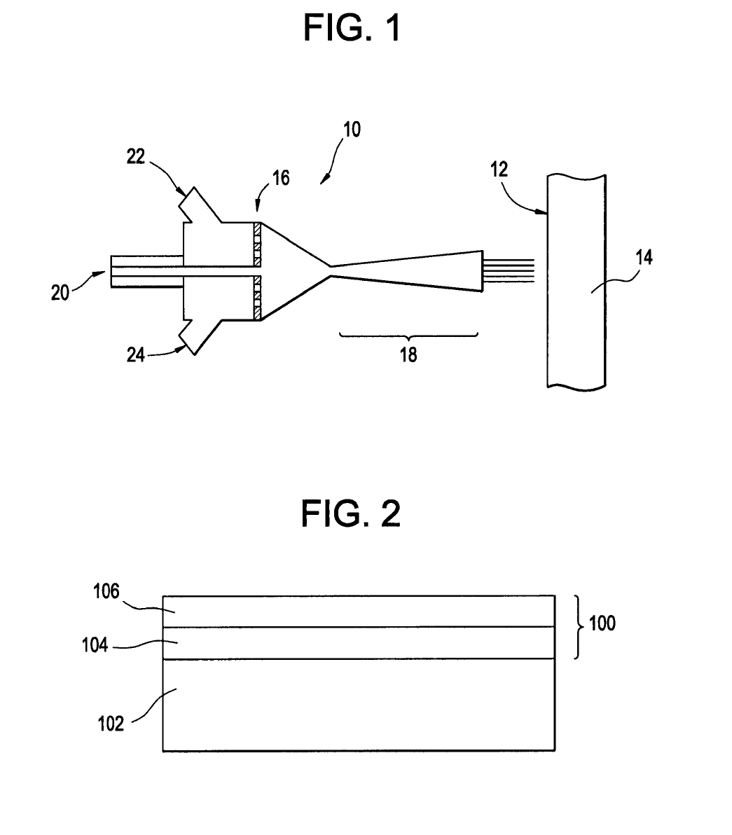

Referring now to FIG. 1, there is shown a system 10 for depositing a powder coating material onto a surface 12 of a turbine rotor 14. The surface 12 of the turbine rotor 14 is configured to be in physical communication with one or more brush or labyrinth seals (not shown) in a turbine engine. The system 10 includes a spray gun 16 having a converging/diverging nozzle 18 through which the powdered coating material is sprayed onto the surface 12. The turbine rotor 14 may be formed from any suitable material known in the art. In one embodiment, the turbine rotor 14 can be formed from steel or a superalloy material such as a nickel-based alloy, a copper-based alloy, and the like. During the coating process, the turbine rotor 14 may be held stationary or may be articulated, rotated, or translated by any suitable means (not shown) known in the art.

In the process described herein, a hard coating is applied to the turbine rotor that can comprise a single layer or multiple layers. FIG. 2 illustrates a multilayer hard coating 100 disposed on a turbine rotor substrate 102. In this exemplary embodiment, the hard coating 100 includes a bond coat layer 104 and a wear resistant layer 106 disposed on the bond coat layer 104. In other embodiments, the multilayer hard coating can have less or more layers, including, without limitation, additional wear resistant layers, intermediate layers, barrier layers, protective layers, and the like.

The hard coating 100 includes material that can withstand the conditions experienced by the turbine rotor in the turbine engine operating environment, including substantially resisting wear of both the coating layer and the brush seals when the turbine rotor is in contact with the brush seal bristles or teeth. Exemplary materials for use to form the hard coating can include, for example, a hard metallic or cermet coating material. Hard metallic materials can include superalloys, which are typically nickel-based or cobalt-based alloys, wherein the amount of nickel or cobalt in the superalloy is the single greatest element by weight. Exemplary nickel-based superalloys include, but are not limited to, approximately 40 weight percent nickel (Ni), and at least one component from the group consisting of cobalt (Co), chromium (Cr), aluminum (Al), tungsten (W), molybdenum (Mo), titanium (Ti), tantalum (Ta), niobium (Nb), hafnium (Hf), boron (B), carbon (C), and iron (Fe). Examples of nickel-based superalloys may be designated by, but are not limited to, the trade names Inconel®, Nimonic®, Rene® (e.g., Rene®80-, Rene®95, Rene®142, and Rene®N5 alloys), and Udimet®, Hastelloy®, Hastelloy® S, Incoloy®, and the like. Incoloy® and Nimonic® are trade marks of Special Metals Corporation. Hastelloy® is a trade mark of Haynes International. Alternatively, stainless steels such as 409. 410. 304L. 316 or 321 may be used. Exemplary cobalt-based superalloys include at least about 30 weight percent cobalt, and at least one component from the group consisting of nickel, chromium, aluminum, tungsten, molybdenum, titanium, and iron. Examples of cobalt-based superalloys are designated by, but are not limited to, the trade names Haynes®, Nozzaloy®, Stellite® and Ultimet®. Stellite® is a trade mark of Deloro Stellite. Exemplary cermet materials can include, without limitation, tungsten carbide-cobalt chromium coatings (WC—CoCr), chromium carbide-nickel chromium coatings (CRC/Ni—Cr), and the like. Again, the material described herein for the hard coating can be used to form a stand alone coating or the materials can be used for a bond coat with metallic and ceramic overcoats, as shown in FIG. 2.

The first layer of the hard coating, whether it is a stand alone layer or the bond coat layer 104 of the multilayer hard coating 100, is applied via the above-described cold spraying process. The material that comprises the bond coat layer 104 is deposited onto the surface of the turbine rotor substrate 102 as a powdered material.

In one embodiment, the bond coat layer 104 is formed of one or more of a nickel-based superalloy and a cobalt-based superalloy, such as those described above. The powdered coating materials that are used to form the deposit on the turbine rotor substrate 102 may have a diameter of about 5 to about 45 micrometers; specifically about 15 to about 22 micrometers. This narrow particle size distribution enables the feedstock particles to be uniformly accelerated and the cold spraying process parameters can be more easily adjusted to accelerate the feedstock above the critical velocity, e.g., the velocity that provides sufficient energy such that, upon impact, the particles plastically deform and bond to the surface of the turbine rotor. This is because the smaller particles in the feedstock spray will hit the slower, larger ones and effectively reduce the velocity of both. The parameters for the cold spraying process will depend upon gun design, for example, the ratio of the area of nozzle exit to throat, and will be well known to those of skill in the art.

Returning for a moment to FIG. 1, the powdered coating materials are fed into the spray gun 16 via a powder inlet 20. The particles of the powdered coating materials are accelerated to supersonic velocities using compressed gas. The gas is fed to the spray gun 16 via gas inlet 22. The gas forces the powder onto the turbine rotor surface at speeds, typically in a range of between 800 meters per second (m/s) to 1500 m/s. The high-speed delivery causes the powder to adhere to the turbine rotor surface and form the hard coating thereon. Of course it should be understood that delivery speeds can vary to levels below 800 m/s and above 1500 m/s depending on desired adhesion characteristics and powder type. The spray gun 16 can further include a sensor receiver 24 for supporting temperature and/or pressure sensors configured to monitor parameters of the process gas.

When applying the powdered coating materials to form the hard coating on the turbine rotor surface, the spray gun nozzle 18 can be held at a distance from the surface 12, known as the standoff distance. In one embodiment, the standoff distance is about 10 millimeters (mm) to about 100 mm.

Generally, the cold spraying process parameters are adjusted to achieve a hard coating with a fine grained structure, because the fine grain structure of the coating helps achieve a higher strength deposit on the substrate surface. The properly tuned cold spraying process also permits a thicker and denser hard coating than found with other conventional coating processes, because the particles are compressively stressed when deposited. In one embodiment, at least one layer of the hard coating (e.g, the bond coating layer) has a thickness of about 25 micrometers (about 1 mil) to about 2.5 centimeters (about 1 inch); specifically about 250 micrometers (about 1-mils) to about 305 micrometers (about 12 mils). Also unlike conventional coating processes, such as high velocity oxyfuel (HVOF), there is no oxidation or phase change (e.g., melting) of the materials during the cold spraying process. The lack of oxide layers and internal stresses in the cold sprayed coating compared to conventional coating techniques provides a coating that is less brittle and more ductile, meaning the coating is less prone to crack propagation and coating spallation. All of the above effects of the cold spraying process result in a hard coating on the turbine rotor that provides a higher degree of wear protection and substantial resistance to brush seal wear compared to coatings applied using conventional coating processes.

In certain embodiments, the cold sprayed coating layer can undergo further processing prior to application of additional layers thereon or after the multilayer coating has been formed. For example, the cold sprayed bond coating layer 104 or the multilayer hard coating 100 can undergo post-processing techniques, such as, for example, shot peening, sonic peening, laser shock peening, burnishing, heat treatment, combinations thereof, and the like. The post-processing techniques can improve the fatigue properties of the coating by inducing compressive stresses and/or removing sharp edges from the surface that can act as stress raisers. The post-processing techniques can also be effective in reducing or eliminating tensile residual stress, and improving integrity of the coating by promoting diffusion of the layers.

Turning back to FIG. 2, the multilayer hard coating 100 includes a wear resistant or top coat layer 106 disposed over the bond coating layer 104, which has been applied via the cold spraying process for the benefits described above. The wear resistant layer 106 can comprise any coating material known in the art for reducing surface wear in a turbine engine caused by the harsh conditions of the environment and/or physical contact with the brush seals. In one embodiment, the wear resistant layer 106 will comprise the same material as the brush seal surface. Exemplary materials for the wear resistant layer can include, without limitation, cobalt alloys such as L605 (Haynes® 25) or Haynes® 188 or Stellite® 6B, Nozzaloy®, Ultimet®, and the like. The wear resistant layer can also be formed of cermet materials such as, without limitation, tungsten carbide-cobalt chromium coatings (WC—CoCr), chromium carbide-nickel chromium coatings (CRC/Ni—Cr), and the like.

The wear resistant layer 106 can be formed using conventional methods known to those skilled in the art and will depend largely upon the material chosen to form the layer. Exemplary methods for forming the wear resistant layer 106 of the hard coating 100 can include, without limitation, plasma spraying, high velocity plasma spraying, low pressure plasma spraying, solution plasma spraying, suspension plasma spraying, chemical vapor deposition (CVD), electron beam physical vapor deposition (EBPVD), sol-gel, sputtering, slurry processes such as dipping, spraying, tape-casting, rolling, painting, and combinations of these methods. Once coated the layer can optionally be dried and sintered. In one embodiment, the wear resistant layer 106 is formed using a cold spraying process.

After application of the hard coating onto the turbine rotor, the hard coating can be surface finished to a desired surface roughness, such as a mirror finish. Polishing the hard coating can significantly reduce the friction between the turbine rotor surface and the brush seals, thereby further improving the operating life of both the brush seals and the turbine rotor coating. Surface finishing techniques can include, for example, grinding, lapping, polishing, and the like. The hard coating surface can have a surface roughness of about 0.001 micrometer roughness average (Ra) to about 5 micrometer Ra; specifically about 0.01 micrometer Ra to about 0.1 micrometer Ra.

To reiterate, the major technical advantage with the coated turbine rotor described herein is lower brush teeth wear compared to wear of the brush seal teeth with an uncoated turbine rotor. This improved resistance to surface wear is achieved by using cold sprayed hard coatings that are dense, hard, and substantially wear resistant and which can be finished to very fine surface finishes. Reducing the brush seal wear and improving the operating life thereof reduces turbine power loss due to leakage, thereby resulting in improved power output and economy for the turbine engine.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A process for applying a hard coating to a turbine rotor, comprising:
applying a first coating to at least one surface of the turbine rotor, the first coating being cold sprayed onto the at least one surface;
applying a second coating onto the first coating to form the hard coating, wherein the hard coating is configured to substantially resist wear of a brush seal in physical communication with the turbine rotor.

2. The process of claim 1, wherein the second coating is applied by a coating method selected from the group consisting of plasma spraying, high velocity plasma spraying, low pressure plasma spraying, solution plasma spraying, suspension plasma spraying, chemical vapor deposition, electron beam physical vapor deposition, high velocity oxy-fuel flame spraying, sol-gel, sputtering, and slurry process.

3. The process of claim 1, wherein the second coating is applied by cold spraying onto the first coating.

4. The process of claim 1, wherein the first coating comprises a bond coat layer.

5. The process of claim 4, wherein the second coating comprises a wear resistant layer.

6. The process of claim 5, wherein the bond coat layer comprises a nickel-based superalloy comprising approximately 40 weight percent nickel, and at least one component from the group consisting of cobalt, chromium, aluminum, tungsten, molybdenum, titanium, tantalum, Niobium, hafnium, boron, carbon, and iron.

7. The process of claim 5, wherein the bond coat layer comprises a stainless steel.

8. The process of claim 5, wherein the wear resistant layer comprises a cobalt-based superalloy comprising at least about 30 weight percent cobalt, and at least one component from the group consisting of nickel, chromium, aluminum, tungsten, molybdenum, titanium, and iron.

9. The process of claim 5, wherein the wear resistant layer comprises a cermet material.

10. The process of claim 9, wherein the cermet material comprises tungsten carbide-cobalt chromium (WC—CoCr) or chromium carbide-nickel chromium coatings (CRC/Ni—Cr).

11. The process of claim 1, further comprising post-processing the hard coating with a method selected from the group consisting of shot peening, sonic peening, laser shock peening, burnishing, and heat treatment.

12. The process of claim 11, further comprising finishing a surface of the hard coating to a surface roughness of about 0.01 micrometer roughness average to about 0.1 micrometer roughness average with a method selected from the group consisting of grinding, lapping, and polishing.

13. The process of claim 1, wherein the hard coating has a thickness of about 25 micrometers to about 2.5 centimeters.

14. The process of claim 1, wherein applying the first coating to the at least one surface comprises cold spraying a powdered material having a plurality of particles, wherein the plurality of particles have a particle diameter of about 15 micrometers to about 22 micrometers.

15. A turbine rotor in physical communication with a brush seal, comprising:
at least one turbine rotor surface; and
a hard coating comprising a bond coat layer and at least one wear resistant layer disposed on the at least one turbine rotor surface, at least the bond coat layer being cold sprayed on the at least one turbine rotor surface, wherein the hard coating is configured to substantially resist wear of the brush seal during rotation of the turbine rotor.

16. The turbine rotor of claim 15, wherein the bond coat layer comprises a nickel-based superalloy comprising approximately 40 weight percent nickel, and at least one component from the group consisting of cobalt, chromium, aluminum, tungsten, molybdenum, titanium, tantalum, Niobium, hafnium, boron, carbon, and iron, and the wear resistant layer comprises a cobalt-based superalloy comprising at least about 30 weight percent cobalt, and at least one component from the group consisting of nickel, chromium, aluminum, tungsten, molybdenum, titanium, and iron.

17. The turbine rotor of claim 16, wherein the hard coating has a thickness of about 25 micrometers to about 2.5 centimeters.

18. A process of substantially resisting surface wear of a brush seal system in a turbine engine, the process comprising:
applying a hard coating to at least one surface of a turbine rotor, wherein the at least one surface is in physical communication with the brush seal system, and wherein applying the hard coating comprises
cold spraying a first coating to the at least one surface; and
applying a second coating onto the first coating to form the hard coating.

19. The process of claim 18, wherein the first coating is a bond coat layer and the second coating is a wear resistant layer.

20. The process of claim 19, further comprising finishing a surface of the hard coating to a surface roughness of about 0.01 micrometer roughness average to about 0.1 micrometer roughness average with a method selected from the group consisting of grinding, lapping, and polishing.
